(19) United States
(12) Patent Application Publication
(10) Pub. No.: US 2008/0155951 A1
(43) Pub. Date: Jul. 3, 2008

(54) POROUS SUBSTRATE FOR USE AS A PARTICULATE FILTER FOR CATALYTIC OR NON-CATALYTIC SUPPORTED SOOT REGENERATION

(75) Inventors: Elmar Riesmeier, Aachen (DE); Christoph Boerensen, Aachen (DE); Alexei A. Dubkov, Aachen (DE); Gary M. Crosbie, Dearborn, MI (US)

Correspondence Address: ALLEMAN HALL MCCOY RUSSELL & TUTTLE, LLP, 806 S.W. BROADWAY, SUITE 600, PORTLAND, OR, 97205, US

(73) Assignee: FORD GLOBAL TECHNOLOGIES, LLC, Dearborn, MI (US)

(21) Appl. No.: 11/968,305

(22) Filed: Jan. 2, 2008

(30) Foreign Application Priority Data
Jan. 3, 2007 (EP) 07100055.8

(51) Int. Cl. B01D 63/06

(52) U.S. Cl. 55/522

(57) ABSTRACT

A porous substrate is described for use as a particulate filter for catalytic or non-catalytic supported soot regeneration methods. The substrate employs catalytic and/or non-catalytic forms of soot regeneration. The substrate has a honeycomb structure and filters, during operation of the particulate filter, nanoparticles in an exhaust gas flow through the porous substrate. The porous substrate is characterized by having a cell density in the region from 200 to 300 CPSI, a wall thickness of 10 to 16 mil, a porosity of 35 to 55% and a pore size of 9 to 15 μm.

The present application claims priority to European Patent Application No. 07100055.8, entitled “POROUS SUBSTRATE FOR USE AS A PARTICULATE FILTER FOR CATALYTIC OR NON-CATALYTIC SUPPORTED SOOT REGENERATION METHODS”, filed Jan. 3, 2007, the entire contents of which are incorporated herein by reference.

### BACKGROUND AND SUMMARY

The present disclosure relates to a porous substrate for use as a particulate filter for automotive and non-automotive applications. The substrate may be designed for catalytic or non-catalytic supported soot regeneration methods.

It will be appreciated that characteristics of the substrate in a particulate filter may determine its ability to filter nanoparticles in the exhaust gas as well as its resistance to flow, i.e. the pressure drop across the filter. US 2005/0042151 A1 discloses that attributes which are desired for high filtration efficiency, namely a low porosity and a small pore size, are opposite to those required for low pressure drop. In order to provide for both a high filtration efficiency and a low pressure drop, US 2005/0042151 A1 proposes a catalytic substrate for hosting a chemical reaction, wherein said substrate comprises a non woven sintered refractory ceramic composite, wherein said composite has a porosity of about 80% to about 99%, a cell density of about 50 to about 1000 channels per square inch (CPSI) and a wall thickness in the region from about 1 to about 20 mil (thousandths of an inch).

U.S. Pat. No. 7,052,532 B1 discloses a high temperature nanofilter including a filter material composed of fibrous filter media having a plurality of fibres and granular filter media having a plurality of granules extending from the surfaces of the fibres. The hybrid filter media has porosity greater than or equal to about 85% and a medium pore size greater than about 30 μm.

The present application may provide a porous substrate for use as a particulate filter for automotive and/or non-automotive applications, which combines a relatively low back pressure with high filtration efficiency as well as a sufficient robustness of the substrate. Furthermore the substrate may be designed for catalytic and/or non-catalytic supported soot regeneration methods. In one example this may be achieved, at least in part, by a porous substrate for use as a particulate filter for automotive and non-automotive applications having a honeycomb structure and filters, where during operation of said particulate filter, nanoparticles in an exhaust gas flow through said substrate. The substrate may have a cell density in the region from 200 to 300 CPSI.

The present disclosure is based at least in part on the consideration that the dominating factors influencing the back pressure in a substrate of a particulate filter are the cell density, the wall thickness, the pore size and the porosity of the substrate. Furthermore, the inventors have recognized that among those four factors, the factors having the biggest influence on the back pressure occurring in the substrate are the cell density and the wall thickness, whereas the pore size and the porosity have relatively less impact.

Since, however, the latter factors (i.e. pore size and porosity) significantly affect the filtration efficiency and the robustness of the filter (i.e. the filter stability) the parameters may be adjusted to relatively low values in order to ensure high filtration efficiency and high robustness of a filter. Further, the remaining factors (i.e. the cell density and the wall thickness) have been varied and numerically analyzed, wherein also an estimation of the shear strength has been performed, considering that at relatively low cell densities, the presence of thin walls enhances a risk of reduced mechanical strength of the substrate.

The parameters of the embodiments of the present disclosure (i.e. a relatively low cell density) may be chosen in spite of the fact that usually, one would expect that a higher cell density is appropriate to reduce the back pressure, because of the enhanced filtration geometric surface area for the same outer filter dimensions and therefore a thinner soot layer being created in the filter substrate.

According to one embodiment, the porous substrate may have a cell density in the region from 210 to 280 CPSI, more specifically in the region from 220 to 270 CPSI. Further the substrate may have a wall thickness in the region from 10 to 16 mil, more specifically in the region from 10 to 13 mil especially of 12 mil. Furthermore, the substrate may have a porosity in the region from 35% to 55%, more specifically a porosity of 42% to 47, and still more specifically of 42%.

Further still, the substrate may have a pore size in the region from 9 to 15 μm, more specifically in the region from 11 to 12 μm.

Further features and advantages of the present disclosure may be gathered from the figures, detailed description and claims.

### BRIEF DESCRIPTION OF THE DRAWINGS

The disclosure is explained below by means of various embodiments, with reference to the accompanying figures in which:

FIG. 1 shows a schematic diagram of an example particulate filter of the present disclosure implemented in an engine system of a vehicle;

FIGS. 2A-2B show diagrams which illustrate the sensitivity of the back pressure with respect to cell density, wall thickness, pore size and porosity for a clean filter sample (i.e. no soot loaded to the filter) (FIG. 2A) and a soot loaded filter sample (FIG. 2B);

FIG. 3 shows a diagram which illustrates the effect of the cell density and wall thickness on the back pressure (ΔP);

FIG. 4 shows a diagram which illustrates the effect of the porosity and the pore size on the back pressure (ΔP);

FIGS. 5A-5D show the results of the determined pressure drop (ΔP) for design of experiment (DOE) variations as a function of the mass flow rate for a clean substrate (FIG. 5A) as well as for different soot loadings of 2 g/L (FIG. 5B), 4 g/L (FIG. 5C) and 6 g/L (FIG. 5D); and

FIG. 6 shows the result of the determined pressure drop for DOE variations as a function of the soot loading and for a mass flow rate of 1.000 kg/h.

### DETAILED DESCRIPTION

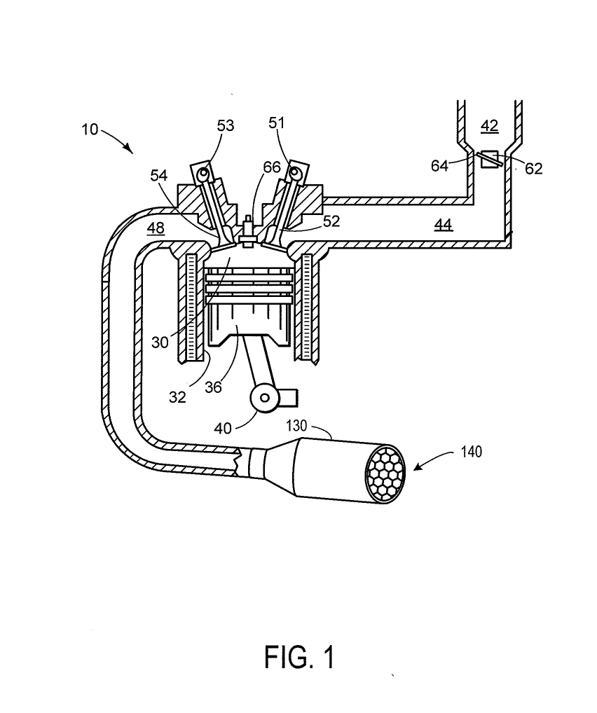

FIG. 1 is a schematic diagram showing one cylinder of multi-cylinder engine 10, which may be included in a propulsion system of an automobile. Combustion chamber (i.e. cylinder) 30 of engine 10 may include combustion chamber walls 32 with piston 36 positioned therein. Piston 36 may be coupled to crankshaft 40 so that reciprocating motion of the piston is translated into rotational motion of the crankshaft. Crankshaft 40 may be coupled to at least one drive wheel of a vehicle via an intermediate transmission system. Further, a starter motor may be coupled to crankshaft 40 via a flywheel to enable a starting operation of engine 10.

Combustion chamber 30 may receive intake air from intake manifold 44 via intake passage 42 and may exhaust combustion gases via exhaust passage 48. Intake manifold 44 and exhaust passage 48 can selectively communicate with combustion chamber 30 via respective intake valve 52 and exhaust valve 54. In some embodiments, combustion chamber 30 may include two or more intake valves and/or two or more exhaust valves. In this example, intake valve 52 and exhaust valves 54 may be controlled by cam actuation via respective cam actuation systems 51 and 53.

In one example, engine 10 may combust diesel fuel and fuel injector 66 may be coupled directly to combustion chamber 30 for injecting fuel directly therein in proportion to a pulse width of signal. In this manner, fuel injector 66 provides what is known as direct injection of fuel into combustion chamber 30. The fuel injector may be mounted in the top of the combustion chamber or in the side of the combustion chamber, for example. Fuel may be delivered to fuel injector 66 by a fuel system (not shown) including a fuel tank, a fuel pump, and a fuel rail.

Intake passage 42 may include a throttle 62 having a throttle plate 64. In this particular example, the position of throttle plate 64 may be varied by an electric motor or actuator included with throttle 62, a configuration that is commonly referred to as electronic throttle control (ETC). In this manner, throttle 62 may be operated to vary the intake air provided to combustion chamber 30 among other engine cylinders.

Residual exhaust gases produced as a product of combustion may be exhausted from combustion chamber 30 into exhaust passage 48 via exhaust valve 54. Exhaust passage 48 may be in communication with particulate filter 130. Particulate filter 130 may include a porous substrate 140 having a honeycomb structure and filters and nanoparticles in the exhaust gas may flow through the porous substrate and soot in the exhaust gas may be retained in the particulate filter. In one particular example, the engine may be a diesel engine and the particulate filter may be a diesel particulate filter. In some embodiments, engine 10 may include additional after-treatment devices to treat exhaust gas in the exhaust passage, such as a three-way catalyst or a selective reduction catalyst, for example. The after-treatment devices may be positioned upstream or down stream of the particulate filter. In some cases, an after-treatment device may be integrated with the particulate filter.

As described above, FIG. 1 shows only one cylinder of a multi-cylinder engine, and that each cylinder may similarly include its own set of intake/exhaust valves, fuel injector, etc. In some embodiments, engine 10 may include a spark plug and may combust fuel via spark ignition.

It will be appreciated that the inventive particulate filter described in further detail below may be used in automotive and/or non-automotive applications.

As discussed above, characteristics of a substrate in a particulate filter may determine the ability of the particulate filter to filter nanoparticles in exhaust gas as well as its resistance to flow, i.e. the pressure drop across the filter. The present disclosure is based on the consideration that the dominating factors influencing the back pressure in a substrate of a particulate filter are the cell density (measured in CPSI=channels per square inch), the wall thickness (measured in mil, 1 mil=1 thousandth of an inch), the pore size (measured in micrometer, μm), and the porosity (measured in percent, %) of the substrate. These factors are explored in further detail below by varying ranges of the factors and applying them to a Latin Hypercube design of experiment (DOE) matrix where the factors have the following boundaries: cell density: 200-300 CPSI, wall thickness: 10-16 mil, pore size: 11-15 μm, and porosity: 42-47%.

For a particular substrate specified by its dimensions and material properties, the back pressure (ΔP) may be calculated using a wall flow particulate filter back pressure model, which is based upon an evaluation of velocities inside the substrate channels and the flow-through walls corresponding to the mass flow rate and the temperature of the exhaust gas. More specifically, the methodology for the calculation of the back pressure (ΔP) using the wall flow particulate filter back pressure model includes the definition of input parameters comprising, the flow conditions (mass flow rate, temperature and cold end pressure), the filter properties (material data, geometry specification), and the DPF (diesel particulate filter) loading state (presence of soot and/or ash being loaded into the filter). Further, methodology for the back pressure calculation includes the calculation of the back pressure (ΔP) by evaluation of the ΔP-contributors (entrance, transition, channel, wall, soot layer and exit losses).

For the ΔP calculation, a laminar channel flow is assumed, so that use is made of the Hagen-Poiseuille friction coefficient, as well as a porous wall/soot layer, so use is made of Darcy's law including the Forchheimer term. Furthermore, use is made of various coefficients for entrance, transition, and exit losses based upon empirically derived equations.

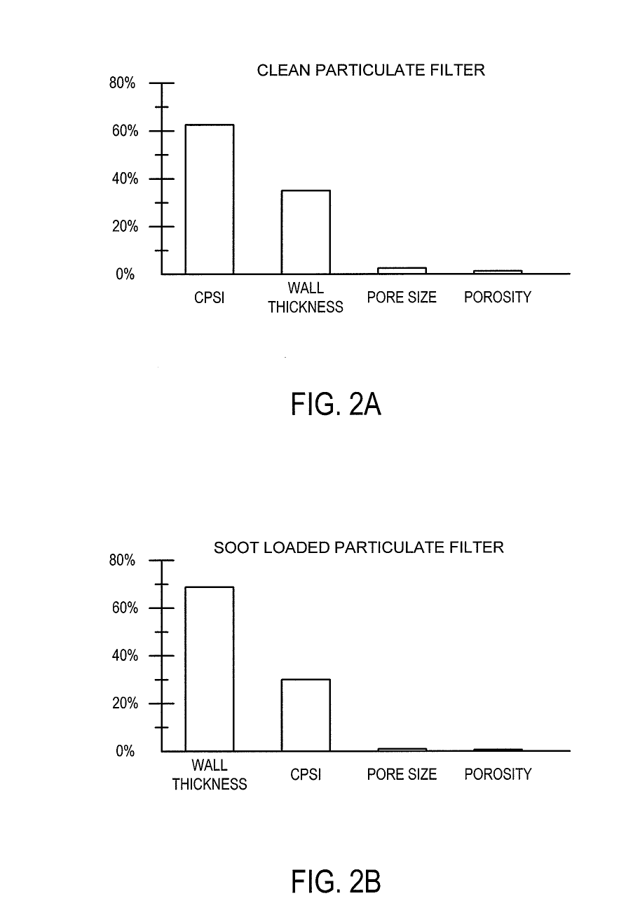

FIGS. 2A and 2B illustrate diagrams showing the results of a sensitivity analysis (giving the total sensitivity in percent) for both a clean filter sample (FIG. 2A) and a soot loaded filter sample (FIG. 2B) of an 8 by 12 inch diesel particulate filter based on the above described statistical model. It can be gathered from FIGS. 2A and 2B that among the above factors (cell density, wall thickness, pore size, and the porosity of the substrate.), the cell density and the wall thickness are the most dominant factors, with the cell density being the major factor if the DPF is clean (i.e. without soot) according to FIG. 2A, and the wall thickness being the major factor if soot is loaded on the DPF according to FIG. 2B.

Note that a higher back pressure results from an increasing soot layer thickness, wherein the soot layer thickness depends on the storage capacity being a function of the wall thickness. Furthermore, it will be appreciated that the sensitivity of factors changes with the DPF size, since the length to diameter ratio determines the ratio of channel to wall losses and the overall DPF size also determines the velocities inside the DPF.

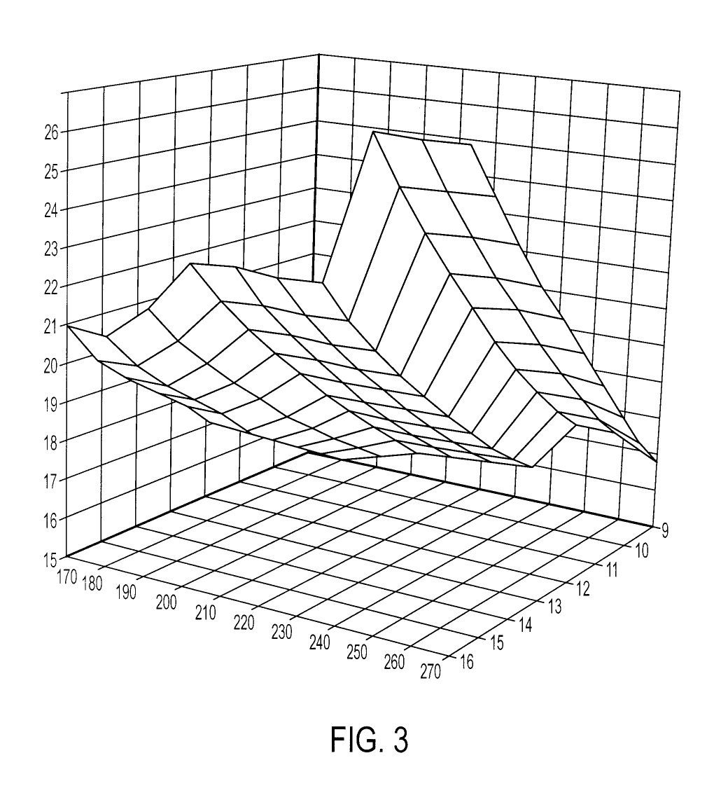

FIG. 3 illustrates the effect of the aforementioned main factors (i.e. cell density and wall thickness) on the back pressure (ΔP) determined for the following boundaries in an 8 by 12 inch DPF: DPF inlet temperature=568° C., soot loading=5 g/L and MFR (=mass flow rate)=770 kg/h. As shown in FIG. 3, a low wall thickness and a low cell density may generally yield the lowest back pressure for the particulate filter.

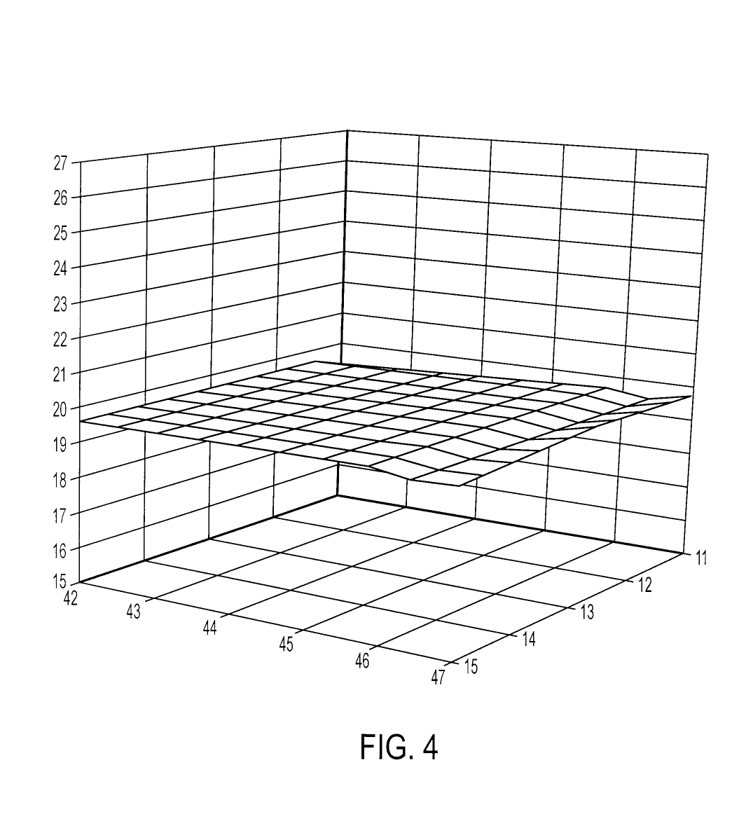

FIG. 4 shows the effect of the secondary factors (i.e. porosity and pore size) for the same boundaries and sample as in FIG. 3. That is, in an 8 by 12 inch DPF: DPF inlet temperature=568° C., soot loading=5 g/L and MFR (=mass flow rate)=770 kg/h. As shown in FIG. 4, both the pore size and the porosity may have only a secondary effect on the back pressure. That is, the back pressure varies relatively little across the range of pore sizes and porosity. Accordingly, the pore size and porosity of a particulate filter substrate may be adjusted in order to achieve high filtration efficiency and high filter stability with little effect on backpressure of the DPF.

As a further aspect, the inventors have considered that the combination of low wall thickness (e. g. 10 mil) with low cell density (e.g. 200 CPSI) may result in production problems with regard to extrusion issues. In the following, a wall flow particulate filter back pressure model is utilized in order to optimize the DPF substrate sample to maintain a low back pressure while, on the one hand, avoiding such production problems and, on the other hand, obtaining sufficient filtration efficiencies and soot storage capacities.

Table 1 (shown below) illustrates the possible combinations of main factors (i.e. wall thickness and cell density) and their impact on aperture ratio (ratio of open frontal area to cross-sectional area of the filter). These combinations are attributed to selected values of the cell density (varied from 178 to 316 CPSI, corresponding to a variation of the number of cells per unit side from 18 to 24) and the wall thickness (varied from 9.84 to 16 mil). Of the combinations of Table 1, the 12/14 mil wall thickness and 220/266 CPSI cell density combinations are chosen by the inventors to be investigated in more detail based on the fact that the substrate configurations provide a reduced risk of filter clogging and production problems while maintaining high storage capacity as well as excellent back pressure performance characteristics. In other words, the samples having the thinnest wall thicknesses and lowest cell densities were avoided due to manufacturability and structural stability impediments. Further, the samples having the thickest wall thickness and the highest cell densities were avoided due to reduced back pressure performance characteristics.

TABLE 1

| cell | wall thickness | | | |
|---|---|---|---|---|
| density | 9.8425 mil | 12 mil | 14 mil | 16 mil |
| 178 CPSI | 35.2% (DOE) | 32.9% (DOE) | 30.9% (DOE) | 28.9% |
| 220 CPSI | 34.0% (DOE) | 31.5% (DOE) | 29.3% (DOE) | 27.1% (DOE) |
| 266 CPSI | 32.9% (DOE) | 30.2% (DOE) | 27.8% (DOE) | 25.5% (DOE) |
| 316 CPSI | 31.8% | 28.9% (DOE) | 26.4% (DOE) | 23.9% (DOE) |

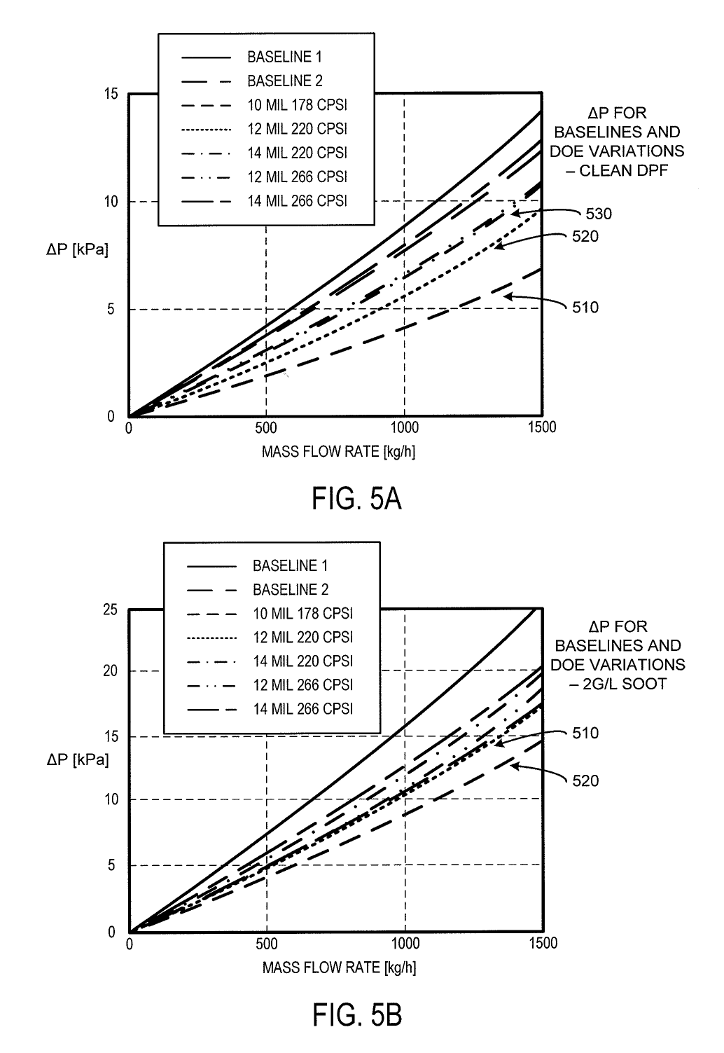

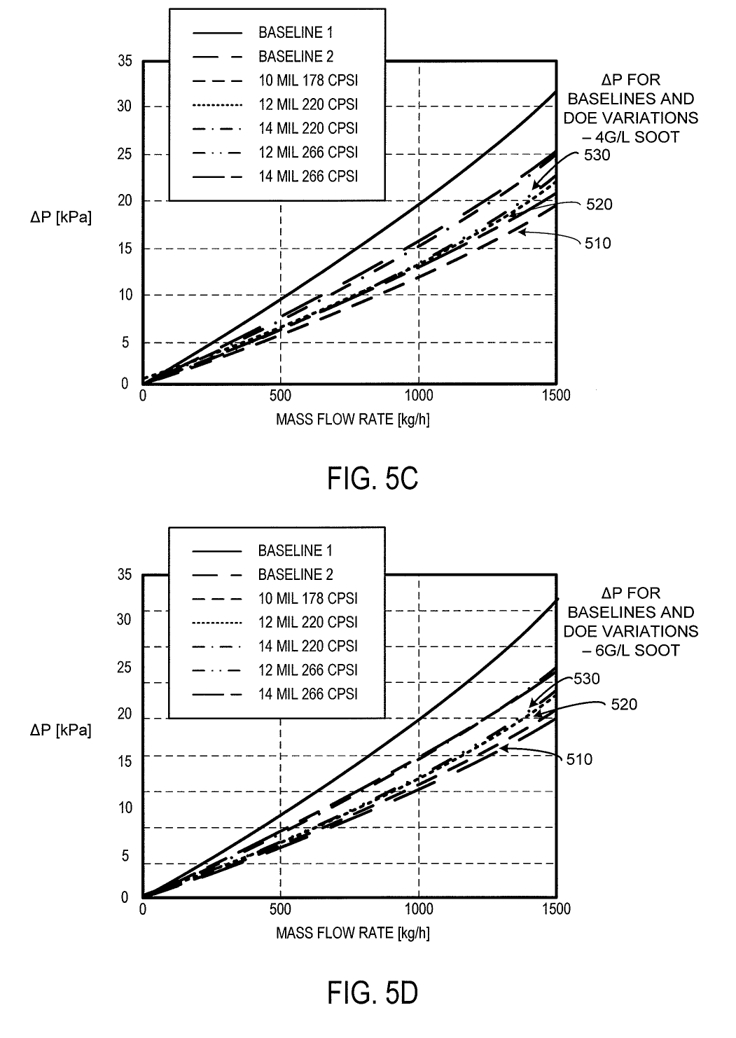

FIGS. 5A-5D show the results of the determined pressure drop (ΔP) for the above described DOE variations as a function of the mass flow rate for a clean substrate as well as for different soot loads. In particular, FIG. 5A shows the functions of the substrate variations generated for a clean particulate filter condition. FIG. 5B shows the function of the substrate variation generated from the particulate filter being load with 2 g/l of soot. FIG. 5C shows the function of the substrate variation generated from the particulate filter being load with 4 g/l of soot. FIG. 5D shows the function of the substrate variation generated from the particulate filter being load with 6 g/l of soot. Furthermore, FIGS. 5A-5D show the result of the determined pressure drop for DOE variations as a function of the soot loading and for a mass flow rate of 1.000 kg/h.

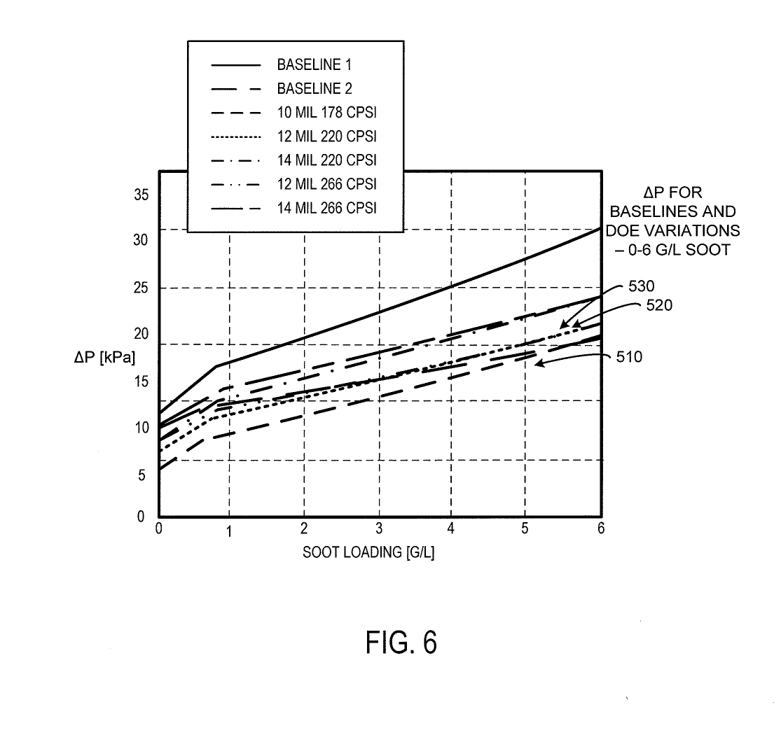

In FIGS. 5A-5D and FIG. 6, the sample “baseline” has the following parameters: cell density =178 CPSI, wall thickness=16 mil, pore size=11 μm and porosity=42%. The sample “baseline 2” has the following parameters: cell density=316 CPSI, wall thickness=10 mil, pore size=11 μm and porosity=42%.

As illustrated in FIGS. 5A-5D and FIG. 6, the sample generally referenced at 510 and having a wall thickness of 10 mil and a cell density of 178 cpsi may be the least robust of the samples since it demonstrates the lowest rate of backpressure vs mass flow rate across the various soot loaded operating conditions. In particular, with reference to FIG. 6, sample substrate variation 510 provides the lowest level of drop in pressure (or backpressure) across the various soot loaded conditions of particulate filter operation.

On the other hand, the best DOE variation selection may be achieved for the samples generally referenced at 520 and 530 and having a wall thickness of 12 mil combined with a cell density of either 220 CPSI or 266 CPSI, respectively. As shown in FIGS. 5A-5D and 6, sample substrate variations 520 and 530 may have the lowest DOE variation across the various soot loaded conditions of particulate filter operation.

As a conclusion of the above results, an improvement of the back pressure characteristics according to the present invention may be achieved by reducing the wall thickness to 12 mil while maintaining the cell density at moderately low value (220 or 266 CPSI). Because of the chosen cell density, the risk of clogging is reduced with respect to, for example, a sample having a cell density of 316 CPSI, while maintaining excellent back pressure characteristics performance under both clean and soot loaded conditions.

Turning now to Table 2 (shown below), an estimation of the shear strength of each sample based on the substrate parameters is shown. In particular, the input cell density and the input wall thickness are varied while the porosity and pore size are fixed at constant values. It can be gathered from Table 2 that at relatively low cell densities of 200 CPSI, the presence of thin walls (e.g. walls of 8-10 mil) may result in low shear strengths and enhances a risk of reduced mechanical strength of the substrate. Accordingly, a sufficient robustness could be obtained for a medium cell density of 220 CPSI or 266 CPSI and a moderate wall thickness of 12 mil.

TABLE 2

| | Wall | | |
|---|---|---|---|
| Nominal cell | thickness | Calculated cell | Calculated shear |
| density (CPSI) | (mil) | spacing (mm) | strength (MPa) |
| 200 | 16 | 1.796 | 0.902 |
| 200 | 12 | 1.796 | 0.507 |
| 200 | 10 | 1.796 | 0.352 |
| 200 | 8 | 1.796 | 0.225 |
| 220 | 16 | 1.712 | 0.992 |
| 220 | 12 | 1.712 | 0.558 |
| 220 | 10 | 1.712 | 0.387 |
| 220 | 8 | 1.712 | 0.248 |
| 266 | 16 | 1.557 | 1.199 |
| 266 | 12 | 1.557 | 0.675 |
| 266 | 10 | 1.557 | 0.468 |
| 266 | 8 | 1.557 | 0.300 |
| 300 | 16 | 1.466 | 1.352 |
| 300 | 12 | 1.466 | 0.761 |
| 300 | 10 | 1.466 | 0.528 |
| 300 | 8 | 1.466 | 0.338 |

As a result of the above discussed analysis, the desired combination of good back pressure characteristics with sufficient robustness and filtration efficiency at a low risk of filter clogging may be achieved with a medium cell density of 220 or 266 CPSI at a moderate wall thickness of 12 mil (1 mil=1 thousandth of an inch).

In particular, it has been recognized by the inventors that the risk of clogging for such an optimized substrate (with cell density=220 or 266 CPSI and wall thickness=12 mil) has been significantly reduced compared to a sample having a significantly higher cell density (namely a cell density of 316 CPSI). An explanation for this effect is the smaller inlet channel diameter in a substrate having a higher cell density, leading to a higher risk of clogging on the front part of the filter and thereby an inhibition of homogenous soot distribution inside the filter. Consequently, the risk of clogging is, for the inventive substrate significantly lower than for a substrate which exhibits a high cell density, which is due to larger inlet channels in the substrate optimized according to the present invention.

It will be appreciated that the configurations disclosed herein are exemplary in nature, and that these specific embodiments are not to be considered in a limiting sense, because numerous variations are possible. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A particulate filter having catalytic and non-catalytic forms of soot regeneration, comprising:
a porous substrate having a honeycomb structure and filters configured such that during operation an exhaust gas having nanoparticles flows through the honeycomb structure and filters of the porous substrate, wherein the porous substrate has a cell density in a region from 200 to 300 CPSI.

2. The particulate filter according to claim 1, wherein the porous substrate has a cell density in a region from 210 to 280 CPSI.

3. The particulate filter according to claim 1, wherein the porous substrate has a cell density in a region from 220 to 270 CPSI.

4. The particulate filter according to claim 1, wherein the porous substrate has a wall thickness in a region from 10 to 16 mil.

5. The particulate filter according to claim 1, wherein the porous substrate has a wall thickness in a region from 10 to 13 mil.

6. The particulate filter according to claim 1, wherein the porous substrate has a wall thickness in a region of 12 mil.

7. The particulate filter according to claim 1, wherein the porous substrate has a porosity in a region from 35% to 55%.

8. The particulate filter according to claim 1, wherein the porous substrate has a porosity in a region from 42% to 47%.

9. The particulate filter according to claim 1, wherein the porous substrate has a porosity in a region of 42%.

10. The particulate filter according to claim 1, wherein the porous substrate has a pore size in a region from 9 to 15 μm.

11. The particulate filter according claim 1, wherein the porous substrate has a pore size in a region from 11 to 12 μm.

12. The particulate filter according to claim 1, wherein the particulate filter has dimension of eight inches by twelve inches.

13. A particulate filter having catalytic and non-catalytic forms of soot regeneration, comprising:
a porous substrate having a honeycomb structure and filters configured such that during operation an exhaust with gas nanoparticles flows through the honeycomb structure and filters of the porous substrate, wherein the porous substrate has a cell density in the region from 220 to 270 CPSI, wherein the porous substrate has a wall thickness in the region of 12 mil, wherein the porous substrate has a porosity in the region of 42%, and wherein the porous substrate has a pore size in the region from 11 to 12 μm.

14. A particulate filter having catalytic and non-catalytic forms of soot regeneration, comprising:
a porous substrate having a honeycomb structure and filters configured such that during operation an exhaust gas having nanoparticles flows through the honeycomb structure and filters of the porous substrate, wherein the porous substrate has a cell density in a region from 200 to 300 CPSI, wherein the porous substrate has a wall thickness in a region from 10 to 16 mil, and wherein the porous substrate has a porosity in a region from 35% to 55%.

15. The particulate filter according to claim 14, wherein the porous substrate has a cell density in a region from 210 to 280 CPSI.

16. The particulate filter according to claim 14, wherein the porous substrate has a cell density in a region from 220 to 270 CPSI, and wherein the porous substrate has a pore size in a region from 9 to 15 μm.

17. The particulate filter according to claim 14, wherein the porous substrate has a wall thickness in a region from 10 to 13 mil.

18. The particulate filter according to claim 14, wherein the porous substrate has a wall thickness in a region of 12 mil.

19. The particulate filter according to claim 14, wherein the porous substrate has a porosity in a region from 42% to 47%.

20. The particulate filter according to claim 14, wherein the porous substrate has a porosity in a region of 42%.

21. The particulate filter according claim 14, wherein the porous substrate has a pore size in a region from 11 to 12 μm.
